(19) United States
(12) Patent Application Publication
(10) Pub. No.: US 2013/0270392 A1
(43) Pub. Date: Oct. 17, 2013

(54) INTERFACE ARRANGEMENT FOR AIRCRAFT LIFTING SURFACE

(71) Applicant: Airbus Operations, S.L., (US)

(72) Inventors: FERNANDO MAESTRE DERQUI, Madrid (ES); IGNACIO OUTON HERNÁNDEZ, Madrid (ES)

(21) Appl. No.: 13/829,629

(22) Filed: Mar. 14, 2013

(30) Foreign Application Priority Data
Apr. 17, 2012 (ES) 201230570

(51) Int. Cl. B64C 23/00

(52) U.S. Cl. CPC B64C 23/00
USPC 244/130

(57) ABSTRACT

Interface arrangement for aircraft lifting surface between a first component and a second component made of composite materials and having an aerodynamic contour, wherein the first component comprises a primary joggled area and the second component comprises a secondary joggled area, such that the first component is joined to the second component by means of a supplementary part which accommodates in the primary joggled area and in the secondary joggled area, the secondary part being designed to maintain continuity of aerodynamic contour at the interface arrangement and to fill the gap between the first component and the second component, so the maximum thickness of the supplementary part being the depth of the primary joggled area, the depth of the primary joggled area being lower than the depth needed to accommodate the second component on the first component.

### CROSS-REFERENCE TO RELATED APPLICATION

This application claims the benefit of the filing date of Spanish Application Serial No. 201230570 filed Apr. 17, 2012 the disclosure of which is hereby incorporated herein by reference in its entirety.

### TECHNICAL FIELD OF THE INVENTION

The invention refers to an interface arrangement for an aircraft structure that has an aerodynamic contour and, more in particular, to an interface arrangement to maintain the continuity of the aerodynamic contour of the interface.

### BACKGROUND

It is well known that weight is a fundamental aspect in the aeronautical industry. Therefore, the current way forward in this industry is to use composite materials instead of metallic materials to be used in aircraft structures with an aerodynamic contour such as lifting surfaces and fuselages.

The composite materials commonly used in the aeronautical industry consist of fibers or fiber bundles embedded in a matrix of thermosetting or thermoplastic resin, as a preimpregnated or “prepreg” material. Their main advantages are:
their high specific strength with respect to metallic materials: strength/weight equation;
their excellent behavior against fatigue loads;
the possibilities of structural optimization due to the anisotropy of the material and the possibility of combining fibers with different orientations, allowing the design of the elements with different mechanical properties to be adjusted to the different needs in terms of applied loads.

The main structure of an aircraft lifting surface consists of a leading edge, a torsion box, a trailing edge, a root joint and a tip. The torsion box can be broken down in several structural elements: upper and lower skins stiffened by stringers on one side; spars and ribs on the other side, among other elements. Typically, the structural elements of the torsion box are manufactured separately and are joined together with the aid of appropriate tooling to achieve the necessary required tolerances.

The interface between those components shall be arranged to comply with the aerodynamic requirements in terms of continuity, smoothness and drag in the interface area. This interface outer surface belongs to the aircraft aerodynamic contour like the interface of a wing skin (upper or lower skin of the torsion box) with a leading edge panel in the case of a lifting surface of an aircraft.

It is well known in the prior art the use of aerodynamic smoothing sealants to fill the gaps involved in the mentioned interfaces. These sealants are typically uncured pastes suitable for application by extrusion gun or spatula. They can cure at low temperatures and have a good adhesion to common aircraft substrates. However, when these gaps have certain dimensions, the application and maintenance of these sealants raise several problems such as cracking, loosening or even coming off.

It is also known in the state of the art the use of interface arrangements between a first and a second component, made of composite materials, of an aircraft structure with an aerodynamic contour. Sometimes, the first component contains a joggle designed to accommodate the second component, so that the complete structure is shaped to maintain the continuity of the aerodynamic contour in the cited interface area between the components.

In the case of the interface between the upper or the lower skin of the torsion box (wing skin) and a panel of the leading edge, the wing skin will have a joggle intended to accommodate the leading edge panel. The leading edge panel is a single unitary part, its thickness allows it to withstand both the aerodynamic and the structural loads in flight. The depth of the joggle for the leading edge panel is limited due to manufacturing requirements of the wing skin, especially in composite materials. It may happen a situation in which the thickness requirement for the leading edge panel to withstand loads is bigger than the maximum allowed joggle depth given by the manufacturing requirements. In these cases, the solution proposed above cannot be implemented.

Therefore, the invention is focused on the solution of this situation.

### SUMMARY

An objective of the present invention is to provide an interface arrangement between components of an aircraft structure made of composite materials that have an aerodynamic contour that ensures the continuity of the aerodynamic contour in that interface area.

Another objective of the present invention is to provide an interface arrangement between components of an aircraft structure made of composite materials that have an aerodynamic contour allowing an easy maintenance and a weight reduction, compared to the traditional solutions.

Still another object of the invention is to provide an interface arrangement between components of an aircraft structure made of composite materials that have an aerodynamic contour, when at least one of them has severe limitations due to impact and damage tolerance and a decrease in its thickness is not possible since it has to comply with those limitations.

In one aspect these and other objectives are met by an interface arrangement between a first component and a second component of an aircraft structure having an aerodynamic contour, both components being made of composite materials. The first component comprises a primary area which surface belongs to the aircraft aerodynamic contour and a primary joggled area, where the joint with a supplementary part takes place. Furthermore, the second component comprises a secondary area which surface belongs to the aircraft aerodynamic contour and a secondary joggled area, where the joint with the supplementary part takes place. The supplementary part is designed and shaped so as to maintain the continuity of the aircraft aerodynamic contour in the interface area between the first and the second component as well as to fill the expected gap between these components. According to the invention, the joint of the first and second components in the aircraft structure that have an aerodynamic contour is made by means of the supplementary part.

In a preferred embodiment of the invention, the supplementary part is made of Titanium. In another preferred embodiment, this supplementary part is designed as a part belonging to the second component that is joined to the first component, both made in composite material. In a preferred embodiment, the thickness of the supplementary part is comprised between its minimum manufacturing thickness and the maximum manufacturing depth of the primary joggled area of the first component: therefore, the thickness of the supplementary part is such that it allows enough margins to install the fastening elements that will secure the structural safety of the joint of the two components.

One particular field of application of the present invention is the interface between a skin belonging to a torsion box and a leading edge panel in an aircraft lifting surface, such as a wing.

Other characteristics and advantages of the present invention will be clear from the following detailed description of embodiments illustrative of its object in relation to the figures attached.

### BRIEF DESCRIPTION OF DRAWINGS

FIGS. 1a, 1b, 1c and 1d show different views of the location of an interface arrangement between components of an aircraft structure made of composite materials having an aerodynamic contour according to the prior art.

FIG. 2a shows a section side view of an interface arrangement between components of an aircraft structure made of composite materials that have an aerodynamic contour according to the prior art.

FIGS. 2b, 3a and 3b show section side views of the interface arrangement between components of an aircraft structure made of composite materials that have an aerodynamic contour according to the present invention.

### DETAILED DESCRIPTION

A detailed description of the invention for the interface arrangement between a wing skin and a leading edge panel follows.

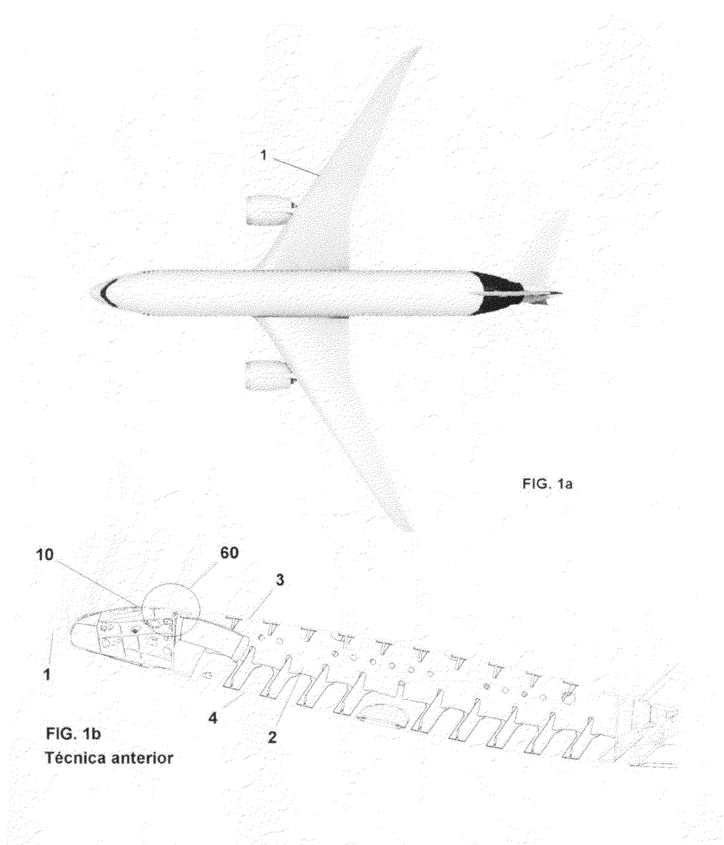

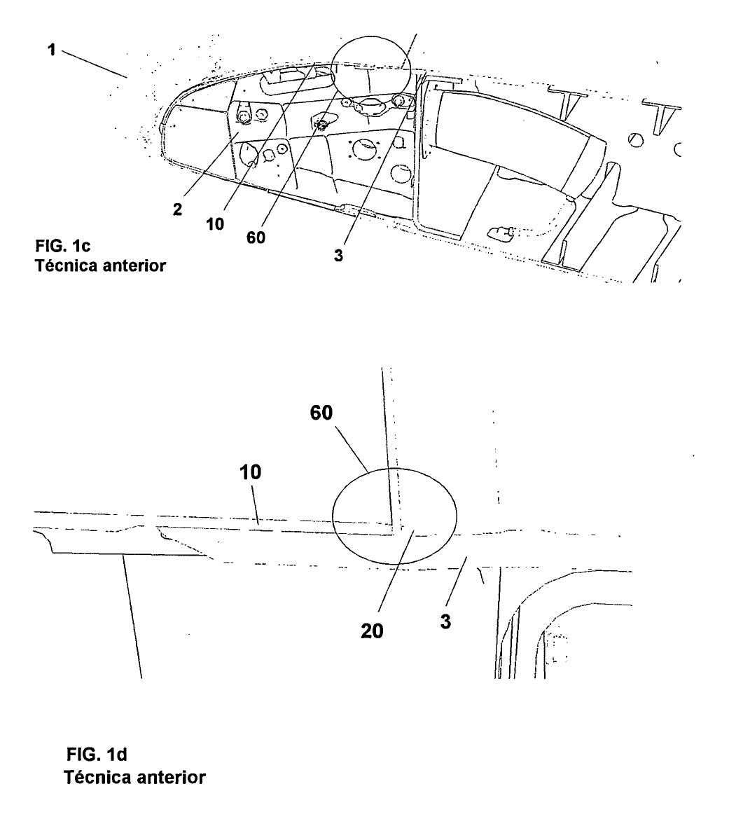

The main structure for aircraft lifting surfaces contains a leading edge 1, a torsion box 2, a trailing edge, a root joint, and a tip. A torsion box 2 structurally consists of spars, ribs and upper and lower skins, 3 and 4, respectively, with several stringers. The upper 3 and lower 4 skins of the torsion box 2 are joined to the leading edge panel 10 and the trailing edge panel shaping the upper and lower wing aerodynamic contour (see FIGS. 1a-1d).

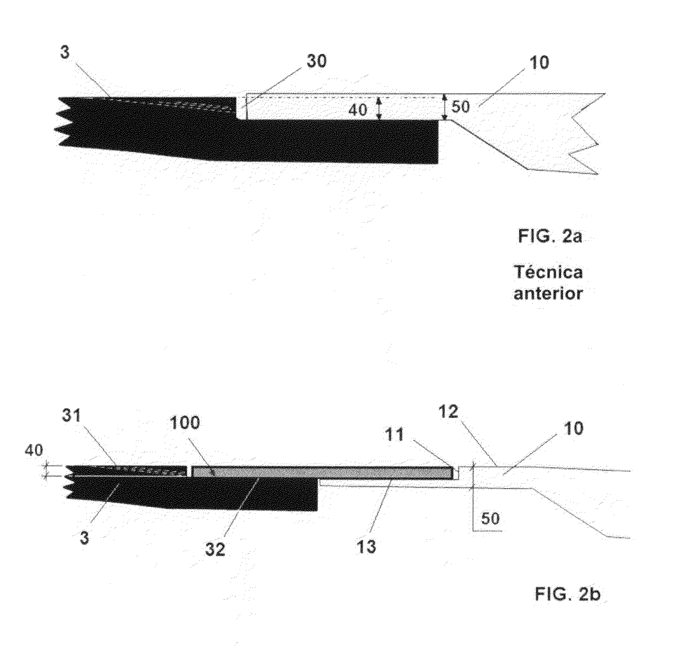

FIGS. 1d and 2a show a known interface arrangement between a first component (wing skin or upper torsion box panel 3) and a second component (leading edge panel 10), made of composite materials, in an aircraft structure with an aerodynamic contour, by means of a wedge part 20. The wing skin 3 comprises a joggle 30 designed to accommodate the leading edge panel 10, being the complete structure of the interface arrangement shaped to maintain the continuity of the aircraft aerodynamic contour.

In the case shown in FIG. 2a, where the leading edge panel 10 is a single unitary part, its thickness allows the withstanding of both the aerodynamic and the structural loads in flight, the depth 40 of the joggle 30 to accommodate the leading edge panel 10 is limited by manufacturing requirements of the wing skin 3, so the maximum depth 40 possible is less than the depth 50 needed to properly accommodate the leading edge panel 10. In that case, the interface arrangement of the present invention (FIG. 2b) is applied, as it will be further explained.

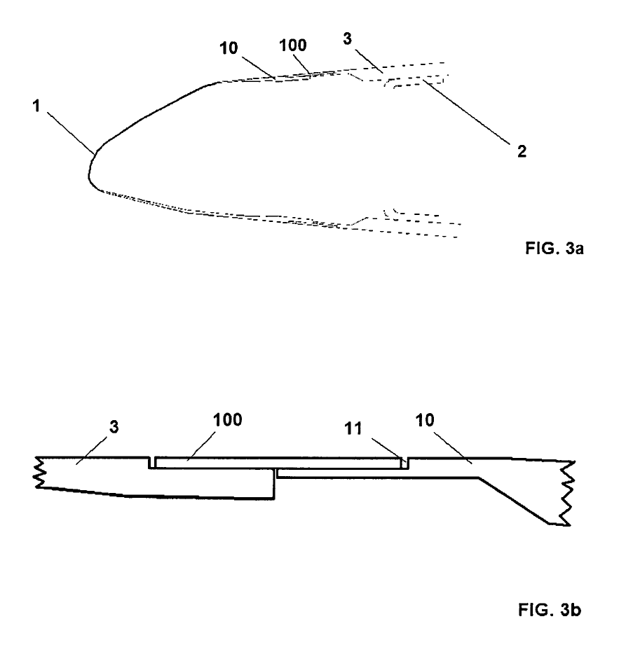

The interface arrangement according to the present invention between a wing skin 3 and a leading edge panel 10 of an aircraft structure with an aerodynamic contour, both components being made of composite materials, is such that the wing skin 3 comprises a primary area 31 which surface belongs to the aircraft aerodynamic contour and a primary joggled area 32 where the joint with a supplementary part 100 takes place (see FIG. 2b). Furthermore, the leading edge panel 10 comprises a secondary area 12 which surface belongs to the aircraft aerodynamic contour and a secondary joggled area 13 where the joint with the supplementary part 100 takes place. The supplementary part 100 is designed and shaped to maintain the continuity of the aircraft aerodynamic contour in the interface area between the wing skin 3 and the leading edge panel 10, as well as to fill the expected gap between the components. As clearly shown in FIGS. 3a and 3b, the joint of the wing skin 3 and the leading edge panel 10 is made by means of the supplementary part 100.

The invention thus allows the design of interface arrangements having a primary joggled area 32 with a depth 40 that is lower than the depth 50 needed to properly accommodate the leading edge panel 10.

In a preferred embodiment of the invention, the supplementary part 100 is made in Titanium. In another preferred embodiment, this supplementary part 100 is designed as a part belonging to the leading edge panel 10 that is joined to the wing skin 3, both made in composite material.

The main properties of Titanium are indicated herewith:
Young Modulus: 116 GPa
Shear Modulus: 44 GPa
Bulk Modulus: 110 GPa
Tensile Strength: 240-550 MPa
Yield Strength: 138 MPa (minimum)-655 MPa (maximum)
Elongation in 50 mm, minimum 24 at 15%

The main advantages of the interface arrangement according to the invention with respect to the interface arrangements in the prior art are the following:
The previous solutions known in the art do not allow the leading edge panels 10 to have the thickness necessary to withstand the aerodynamic and structural loads required.
Manufacturing defects are diminished because the design of the primary joggled area 32 allows a smaller depth 40.
Load transmission is facilitated, thanks to the lower depth 40 of the primary joggled area 32: this implies a reduction in the thickness of the wing skin 3 and, therefore, a weight reduction.
The invention allows weight reduction versus other different solutions, such as rib reinforcement in the leading edge 1, internal stability plates, etc.
Aerodynamic drag is reduced thanks to the smaller aerodynamic joggle, as titanium has better thickness tolerance compared to composite material, therefore a better control of the joggle being provided.

Although the present invention has been fully described in connection with preferred embodiments, it is evident that modifications may be introduced within the scope thereof, not considering this as limited by these embodiments, but by the contents of the following claims.

1. Interface arrangement between a first component and a second component made in composite materials and having an aerodynamic contour wherein the first component comprises a primary joggled area and the second component comprises a secondary joggled area, such that the first component is joined to the second component by a supplementary part which accommodates in the primary joggled area and in the secondary joggled area, the supplementary part being designed to maintain the continuity of the aerodynamic contour in the interface arrangement and to fill the gap between the first component and the second component, the maximum thickness of the supplementary part being the depth of the primary joggled area, the depth of the primary joggled area being lower than the depth needed to accommodate the second component on the first component.

2. Interface arrangement according to claim 1 wherein the supplementary part is designed as a part belonging to the second component, joined to the first component.

3. Interface arrangement according to claim 1, wherein the supplementary part is made of titanium.

4. Interface arrangement according to claim 1, wherein the first component and the second component belong to an aircraft structure.

5. Interface arrangement according to claim 4 wherein the first component is an upper or lower skin of an aircraft torsion box, and the second component is a leading edge panel in a lifting surface.

6. Interface arrangement according to claim 5 wherein the second component is a leading edge panel in an aircraft wing.

7. Aircraft comprising an interface arrangement according to claim 4.
